(19) United States
(12) Patent Application Publication
(10) Pub. No.: US 2023/0188383 A1
(43) Pub. Date: Jun. 15, 2023

(54) METHOD FOR ESTIMATING SYMBOLS CONVEYED BY A SIGNAL COMPRISING A PLURALITY OF CHIRPS, AND CORRESPONDING COMPUTER PROGRAM PRODUCT AND DEVICE

(71) Applicants: UNIVERSITE DE BORDEAUX, BORDEAUX (FR); INSTITUT POLYTECHNIQUE DE BORDEAUX, TALENCE Cedex (FR); CENTRE NATIONAL DE LA RECHERCHE SCIENTIFIQUE, PARIS (FR)

(72) Inventors: Guillaume FERRE, Gradignan (FR); Mohamed Amine BEN TEMIN, Talence (FR)

(21) Appl. No.: 17/909,747

(22) PCT Filed: Mar. 24, 2021
(86) PCT No.: PCT/FR2021/050507

§ 371 Date: Sep. 6, 2022

(30) Foreign Application Priority Data
Mar. 24, 2020 (FR) FR2002853

(51) Int. Cl. H04L 25/02; H04B 1/69; H04L 7/00

(52) U.S. Cl. CPC H04L 25/0202; H04B 1/69; H04L 7/0016; H04B 2001/6912

(57) ABSTRACT

A method for estimating information symbols conveyed by a signal including modulated chirps. The modulation corresponds to circular permutation of the pattern of variation in the instantaneous frequency of a basic chirp over the symbol time. A first demodulation of a portion of the signal that is representative of at least two chirps delivering: an estimation of a first modulation symbol associated with a first chirp with a stronger amplitude among the two chirps, an estimation of the amplitude and phase of the first chirp, a generation of a signal that is representative of the first chirp from the estimation, and a coherent subtraction of the signal that is representative of the first chirp from the portion of the signal delivering an updated portion of the signal. A second demodulation of the updated portion delivering an estimation of a second modulation symbol associated with a second chirp.

### FIELD OF THE INVENTION

The field of the invention is that of transmitting data via the use of a waveform referred to as “chirp”.

The invention relates more particularly to a method for processing such a waveform that has improved performance relative to the existing techniques with a comparable implementation complexity.

Such a waveform is used for the transmission of data via communication links of different types, e.g., acoustic, radiofrequency, etc. For example, the LoRa® technology dedicated to the low consumption transmission by the connected objects via a radiofrequency link uses such a waveform. The invention thus has applications, in particular, but not exclusively, in all the areas of personal and professional life wherein the connected objects are present. This concerns for example the fields of health, sport, domestic applications (security, household appliances, etc.), object tracking, etc.

### BACKGROUND OF THE INVENTION

Interest is more particularly given in the rest of this document to describing an existing problem in the field of connected objects wherein the LoRa® technology is used and in which the inventors of this patent application were confronted. The invention is of course not limited to this particular field of application but has an interest in the processing of any communication signal based on the use of a waveform referred to as “chirp” in the framework of a communication system wherein the access to the transmission channel is done through contention.

Presented as the “third revolution of the Internet”, connected objects are imposing themselves in all areas of daily life and of the company. Most of these objects are intended to produce data thanks to their built-in sensors so as to provide value-added services for their owner.

Due to the target applications, these connected objects are for the most part mobile. In particular, they must be able to transmit the data produced, regularly or on demand, to an offset user.

To do this, long-range radio transmission of the cellular mobile radio type (2G/3G/4G . . . ) was a technology of choice. This technology indeed made it possible to benefit from network coverage in most countries.

However, the mobile aspect of these objects is often accompanied by a need for autonomy in energy. Yet, even based on one of the most energy-saving cellular mobile radio technologies, the current connected objects continue to have a consumption that is prohibitive in allowing for large-scale deployment at a reasonable cost.

Faced with the problem of the consumption of the radio link for such mobile applications, new low consumption and low speed radio technologies dedicated specifically to the “Internet of Things” networks, i.e., radio technologies for networks referred to as LPWAN (for “Low-Power Wide-Area Networks”), are developed.

In practice, two sorts of technologies can be distinguished:
on the one hand, there are proprietary technologies such as for example the technology from the Sigfox® company, or the LoRa® technology, or the technology from the Qowisio® company. These non-standardized technologies are all based on the use of the “Industrial, Scientific and Medical” frequency band, referred to as ISM, and on the regulations associated with the use thereof. The interest with these technologies is that they are already available and allow for rapid deployment of networks on a limit investment basis. Furthermore, they allow for the development of connected objects that save a substantial amount of energy and at a low cost;
on the other hand, there are several technologies promoted by standardization bodies. As an example, mention can be made of three standardized technologies with 3GPP (for “3rd Generation Partnership Project”): NB-IoT (for “Narrow Band-Internet of Things”), LTE MTC (for “Long Term Evolution-Machine Type Communication”) and EC-GSM-IoT (for “Extended Coverage-GSM-Internet of Things”). Such solutions are based on the use of licensed frequency bands but can also be used over non-licensed frequency bands.

Certain telecommunications operators have already taken an interest in the LoRa® technology to deploy their network dedicated to connected objects. For example, patent EP 2 449 690 B1 describes a technique for transmitting information, on which the LoRa® technology is based. Patent document US 2019/149187 A1 discloses a method for estimating symbols conveyed by a waveform such as used in the LoRa® technology. Patent document US 2019/229958 A1 discloses a method that can be applied to generating and demodulating such a waveform.

However, the initial feedback shows user experiences that are not very satisfactory linked to limited performance of the radio link in actual conditions. In particular, as the access to the radio resources is done through contention in a network of this type, intra-system collisions between emissions of different connected objects to a given base station are inevitable. Yet it appears that it is delicate to manage such collisions with the modulation used.

There is therefore a need to improve the performance in actual conditions of a communication system using a modulation based on the circular permutation of a basic chirp to transmit constellation symbols, such as for example in the LoRa® technology. More particularly, there is a need to improve the robustness of the communication link in the presence of collisions between data frames.

### OBJECT AND SUMMARY OF THE INVENTION

In an embodiment of the invention, a method is proposed for estimating at least two information symbols of a constellation of M symbols conveyed by a signal comprising a plurality of chirps among M chirps. A s-th chirp among the M chirps is associated with a symbol, referred to as modulation symbol, of ranks of the constellation of M symbols, s being an integer from 0 to M−1. The s-th chirp is the result of a modulation of a basic chirp of which an instantaneous frequency varies between a first instantaneous frequency and a second instantaneous frequency during a symbol time T. The modulation corresponds, for the modulation symbol of rank s, to a circular permutation of the variation pattern of the instantaneous frequency over the symbol time T, obtained by a time shift of s times an elementary time duration Tc, such that M*Tc=T. Such a method comprises, for a portion of the signal that is representative of at least two chirps of the plurality of chirps:
a first demodulation of the portion of the signal delivering: an estimation of a first modulation symbol associated with a chirp, referred to as first chirp, of stronger amplitude among the at least two chirps, an estimation of the amplitude of the first chirp, and an estimation of a phase of the first chirp;
a generation of a signal that is representative of the first chirp from estimations of the first modulation symbol, the amplitude of the first chirp, and the phase of the first chirp;
a coherent subtraction of the signal that is representative of the first chirp from the portion of the signal delivering an updated portion of the signal; and
a second demodulation of the updated portion of the signal delivering an estimation of a second modulation symbol associated with a second chirp among the at least two chirps.

Thus, the invention proposes a new and inventive solution to improve the robustness of a communication link based on the use of chirps so as to convey the data symbols.

More particularly, the chirp of stronger amplitude is here seen as an interference from the standpoint of the other chirps comprising the processed signal, in particular when the chirps in question are superimposed at least partially temporally such as arises during an access through contention to the radiofrequency resources. In this way, the estimation of the parameters characterizing the chirp of stronger amplitude, then the subtraction of the signal that is representative of the chirp in question from the processed signal makes it possible to cancel the corresponding interference. The demodulation of the other chirps of the signal thus processed is improved and therefore the overall quality of the communication link as well.

According to an embodiment, the first demodulation and/or the second demodulation comprises a first synchronization comprising, for at least one first elementary portion of duration T of the signal:
a first sampling of the first elementary portion delivering a sequence of first samples;
a first element-wise multiplication between, on the one hand, the sequence of first samples and, on the other hand, a sequence of samples that are representative of a reference chirp referred to as conjugated obtained by application of the modulation to a conjugated basic chirp an instantaneous frequency of which varies between the second instantaneous frequency and the first instantaneous frequency during a time symbol T, the first multiplication delivering a sequence of first multiplied samples; and
a first Fourier transform of the sequence of first multiplied samples delivering a sequence of first transformed samples.

The first synchronization delivers a first piece of synchronization information of the signal according to the first transformed samples.

Thus, a first piece of synchronization information is obtained by searching for a maximum value among the samples delivered (e.g., the maximum value of the modulus of the samples in question) by a Fourier transform carried out on a multiplication of the signal received with a reference chirp, e.g., an expected reference chirp such as can be found in the preamble of a data frame formed according to a particular standard such as the LoRa® standard.

According to an embodiment, the first multiplication and the first Fourier transform are implemented for at least one plurality of first successive elementary portions of duration T of the signal delivering at least one corresponding plurality of sequences of first transformed samples. The first synchronization comprises, for at least one given plurality of sequences of first transformed samples, at least one first averaging according to the first transformed samples of the same rank within sequences of first transformed samples of the given plurality. The first averaging repeated for all the ranks of first transformed samples within sequences of first transformed samples of the given plurality delivers a sequence of first averaged transformed samples. The first piece of synchronization information is according to a maximum value among the first averaged transformed samples.

Thus, the precision of the first synchronization is improved by averaging over several expected reference chirps, e.g., such as can be found in the preamble of a data frame formed according to a particular standard such as the LoRa® standard.

According to an embodiment, the multiplication and the Fourier transform are implemented for at least two pluralities of first successive elementary portions of duration T of the signal delivering at least two corresponding pluralities of sequences of first transformed samples. The first averaging implemented for each plurality of sequences of first transformed samples among the at least two pluralities deliver at least two sequences of first corresponding averaged transformed samples. The first piece of synchronization information is according to a maximum value among the at least two sequences of first averaged transformed samples.

Thus, the expected reference chirps are searched for over different portions of the signal, thereby making it possible to improve the chances of synchronization.

According to an embodiment, the first demodulation and/or the second demodulation delivers the estimations if and only if the maximum value is greater than a first predetermined threshold.

Thus, the method proposed manages false detections of chirps.

According to an embodiment, the first predetermined threshold is according to a number of first elementary portions in a given plurality of first elementary portions.

According to an embodiment, the first demodulation and/or the second demodulation comprises a second synchronization comprising, for at least one second elementary portion of duration T of the signal:
a second sampling of the second elementary portion delivering a sequence of second samples;
a second element-wise multiplication between, on the one hand, the sequence of second samples of the second elementary portion and, on the other hand, a sequence of samples that are representative of a reference chirp among the M chirps, the second multiplication delivering M second multiplied samples; and
a second Fourier transform of the sequence of second multiplied samples delivering a sequence of second transformed samples.

The second synchronization delivers a second piece of synchronization information of the signal according to second transformed samples.

Thus, a second piece of synchronization information is obtained by searching for a maximum value among the samples delivered (e.g., the maximum value of the modulus of the samples in question) by a Fourier transform carried out on a multiplication of the signal received with a reference chirp the instantaneous frequency of which (i.e., the derivative of the instantaneous frequency) has a slope opposite that of the reference chirp sought during the first synchronization. Thus, reference chirps having opposite instant frequency slopes are detected in the processed signal. Such chirps having opposite instant frequency slopes are used in the preamble of the frames according to certain standards such as the LoRa® standard.

As described hereinbelow, the combination of the synchronization information obtained from such chirps having opposite instant frequency slopes makes it possible to differentiate the synchronization errors in time and in frequency.

For example, the second synchronization takes account of the first piece of synchronization information. Thus, the precision of the second piece of synchronization information is improved.

According to an embodiment, the second multiplication and the second Fourier transform are implemented for at least one plurality of second successive elementary portions of duration T of the signal delivering at least one corresponding plurality of sequences of second transformed samples. The second synchronization comprises, for at least one given plurality of sequences of second transformed samples, at least one second averaging according to the second transformed samples of the same rank within sequences of second transformed samples of the given plurality. The second averaging repeated for all the ranks of second transformed samples within sequences of second transformed samples of the given plurality delivers a sequence of second averaged transformed samples. The second piece of synchronization information is according to a maximum value among the second averaged transformed samples.

Thus, the precision of the second synchronization is improved by averaging over several expected reference chirps.

According to an embodiment, the multiplication and the Fourier transform are implemented for at least two pluralities of second successive elementary portions of duration T of the signal delivering at least two corresponding pluralities of sequences of second transformed samples. The second averaging implemented for each plurality of sequences of second transformed samples among the at least two pluralities deliver at least two sequences of corresponding second averaged transformed samples. The second piece of synchronization information is according to a maximum value among the at least two sequences of second averaged transformed samples.

Thus, the expected reference chirps are searched for over different portions of the signal, thereby making it possible to improve the chances of synchronization.

According to an embodiment, one of the first and second pieces of synchronization information is representative of a sum between a time synchronization error and a frequency synchronization error. The other of the first and second pieces of synchronization information is representative of a difference between the time synchronization error and the frequency synchronization error. The second demodulation and/or the second demodulation comprises an addition and a subtraction between the first and second pieces of synchronization information delivering the time synchronization error and the frequency synchronization error.

Thus, the synchronization errors in time (e.g., the sampling instant of the signal) and in frequency (e.g., the error over the carrier frequency of the signal) are both obtained.

According to an embodiment, the first demodulation and/or the second demodulation comprises, for at least one fraction of duration T of the signal portion that is representative of an expected chirp, referred to as expected fraction:
a sampling referred to as synchronized of the expected fraction initiated according to the first piece of synchronization information and/or the second piece of synchronization information delivering a sequence of expected synchronized samples that are representative of the expected chirp;
an element-wise multiplication referred to as synchronized between, on the one hand, the sequence of expected synchronized samples and, on the other hand, the sequence of samples that are representative of the conjugated reference chirp, the multiplication delivering a sequence of expected multiplied synchronized samples; and
a Fourier transform referred to as synchronized of the sequence of expected multiplied synchronized samples delivering a sequence of expected transformed synchronized samples.

An estimation bias of the expected chirp is according to an expected transformed synchronized sample of stronger amplitude. The second demodulation and/or the second demodulation delivers at least one estimation bias corresponding to said at least one expected chirp.

According to an embodiment, the first demodulation and/or the second demodulation comprises, for at least one fraction of duration T of the signal portion that is representative of the first chirp, referred to as first chirp fraction, and/or for at least one fraction of duration T of the signal portion that is representative of the second chirp, referred to as second chirp fraction:
a sampling referred to as synchronized of the first chirp fraction and/or of the second chirp fraction initiated according to the first piece of synchronization information and/or the second piece of synchronization information delivering a sequence of first synchronized samples that are representative of the first chirp and/or a sequence of second synchronized samples that are representative of the second chirp;
an element-wise multiplication referred to as synchronized between, on the one hand, the sequence of first synchronized samples and/or the sequence of second synchronized samples and, on the other hand, the sequence of samples that are representative of the conjugated reference chirp, the multiplication delivering a sequence of first multiplied synchronized samples and/or a sequence of second multiplied synchronized samples; and
a Fourier transform referred to as synchronized of the sequence of first multiplied synchronized samples delivering a sequence of first transformed synchronized samples and/or a Fourier transform referred to as synchronized of the sequence of second multiplied synchronized samples delivering a sequence of second multiplied synchronized samples.

The estimations associated with the first chirp are according to a sample of stronger amplitude among the first transformed synchronized samples and/or the estimations associated with the second chirp are according to a sample of stronger amplitude among the second transformed synchronized samples.

According to an embodiment, the estimations are furthermore according to said at least one estimation bias.

According to an embodiment, the first demodulation comprises a comparison between, on the one hand, the amplitude of the sample of stronger amplitude among the first transformed synchronized samples, referred to as first sample of stronger amplitude, and, on the other hand, a second predetermined threshold. The estimation of the amplitude of the first chirp is according to:
the amplitude of the first sample of stronger amplitude when the amplitude of the first sample of stronger amplitude is less than the second predetermined threshold, and
a predetermined amplitude when the amplitude of the first sample of stronger amplitude is greater than the second predetermined threshold.

The estimation of the phase of the first chirp is according to:
the phase of the first sample of stronger amplitude when the amplitude of the first sample of stronger amplitude is less than the second predetermined threshold, and
a predetermined phase when the amplitude of the first sample of stronger amplitude is greater than the second predetermined threshold.

Thus, different temporally superimposed modulated chirps are not considered as a single and unique chirp by the method proposed. In this way, different modulation symbols, although identical and concomitant temporally, are estimated in the signal received.

According to an embodiment, the synchronized sampling of the first chirp fraction is prolonged over time in such a way as to deliver a plurality of sequences of synchronized samples that are representative of a plurality of successive fractions of duration T of the signal portion. Synchronized element-wise multiplication and the synchronized Fourier transform are implemented for each sequence of synchronized samples of the plurality of sequences of synchronized samples delivering a corresponding plurality of sequences of transformed synchronized samples. The predetermined amplitude is according to an average of the amplitudes of each sample of stronger amplitude of each sequence of transformed synchronized samples. The predetermined phase is according to an average of the phases of each sample of stronger amplitude of each sequence of transformed synchronized samples.

According to an embodiment, the second predetermined threshold is according to the parameter M and the predetermined amplitude.

According to an embodiment, the portion of the signal is representative of at least three chirps of the plurality of chirps and the first chirp is the chirp of stronger amplitude among the at least three chirps. As the second modulation symbol is associated with a chirp, referred to as second chirp, of stronger amplitude after the first chirp among the at least three chirps, the second demodulation delivers an estimation of the amplitude of the second chirp and an estimation of a phase of the second chirp. The method further comprises:
a generation of a signal that is representative of the second chirp from estimations of the second modulation symbol, the amplitude of the second chirp, and the phase of the second chirp;
a coherent subtraction of the signal that is representative of the second chirp from the updated portion of the signal delivering a second updated portion of the signal; and
a third demodulation of the second updated portion of the signal delivering an estimation of a third modulation symbol associated with a third chirp among the at least three chirps.

Thus, a third chirp is demodulated in an improved way.

The invention also relates to a computer program comprising program code instructions for the implementation of a method such as described hereinabove, according to any of its different embodiments, when it is executed on a computer.

In an embodiment of the invention, a device is proposed for estimating at least two information symbols of a constellation of M symbols conveyed by a signal comprising a plurality of chirps among M chirps. Such a device for estimating comprises a programmable calculation machine or a dedicated calculation machine configured to implement the steps of the method for estimating according to the invention (according to any of the aforementioned different embodiments). Thus, the characteristics and advantages of this device are the same as those of the corresponding steps of the method for estimating described hereinabove. Consequently, they are not described in any further detail.

### BRIEF DESCRIPTION OF FIGURES

Other purposes, characteristics and advantages of the invention shall appear more clearly when reading the following description, given as a simple illustrative and non-limited example, in relation with the figures, among which:

FIG. 1 shows a plurality of objects connected to a base station of a radio communication network of the low speed and low consumption type according to an embodiment of the invention;

FIG. 2A shows the instantaneous frequency of a basic chirp;

FIG. 2B shows the modulation of the basic chirp of FIG. 2A via a circular permutation of the variation pattern of its instantaneous frequency;

FIG. 2C shows the instantaneous frequency of the chirp resulting from the modulation of the basic chirp of FIG. 2A via the circular permutation shown in FIG. 2B;

FIG. 3 shows the steps of a method for estimating information symbols carried by a signal comprising a plurality of chirps according to an embodiment of the invention;

FIG. 4A shows the searching for a maximum value among the samples at the output of a Fourier transform carried out over a multiplication of the processed signal with an expected reference chirp such as implemented in certain steps of the method for estimating of FIG. 3 according to an embodiment of the invention;

FIG. 4B shows the searching for a maximum value of a function M(p) such as implemented in certain steps of the method for estimating of FIG. 3 according to an embodiment of the invention;

FIG. 5 shows an example of the device structure allowing for the implementation of the steps of the method for estimating of FIG. 3 according to an embodiment of the invention.

### DETAILED DESCRIPTION OF EMBODIMENTS OF THE INVENTION

The main principle of the invention is based on the estimation of parameters characterizing a first chirp (e.g., the chirp of stronger amplitude) in a signal comprising a plurality of chirps. More particularly, the first chirp is seen as an interference from the standpoint of the other chirps comprising the processed signal, in particular when the chirps in question are temporally superimposed, at least partially, such as arises during an access through contention to the transmission channel. In this way, the estimation of the parameters characterizing the first chirp allows for the generating of a signal that is representative of the first chirp in question. The subtracting, from the processed signal, of the signal that is representative of the first chirp thus makes it possible to reduce the interferences from the standpoint of the other chirps present in the signal. The demodulation of the other chirps of the signal is thus improved and therefore the overall quality of the communication link as well.

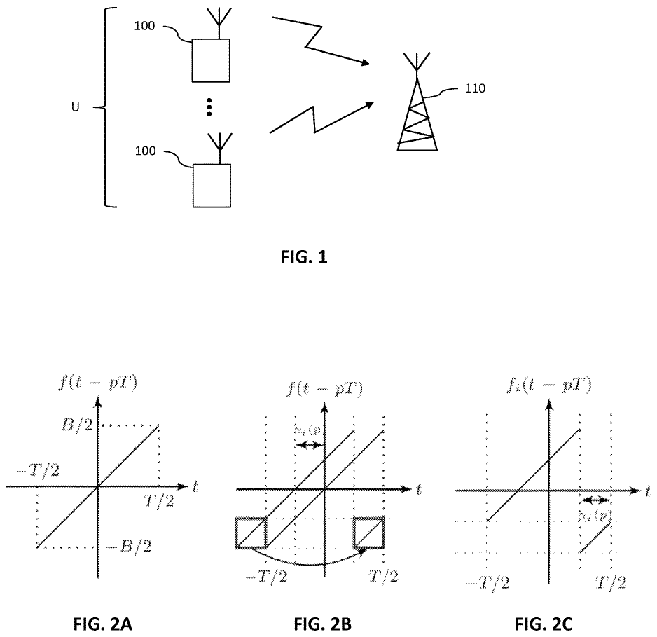

In relation with FIG. 1 a plurality of objects 100 connected to a base station 110 of a radio communication network of the low data rate and low power consumption type is now presented according to an embodiment of the invention.

More particularly, the radio communication network implements the LoRa® communication protocol. According to such a protocol, the transmission of data in the upstream direction between the U objects 100 and the base station 110 is done through contention in the ISM frequency bands. In this way, the probability of data frame collisions at the base station 110 is non-zero and increases with the number U of connected objects 100. Moreover, according to such a protocol, using the same spreading factor SF for the transmission of the chirps by the different objects 100 leads to destructive collisions, i.e., to losses in orthogonality between the chirps, when the chirps in question are transmitted over the same carrier frequency.

In other embodiments, other communication protocols implementing a waveform referred to as “chirp” such as described hereinbelow are considered.

In other embodiments, the objects 100 do not transmit the chirps intended for the base station 110 over the same carrier frequency. However even in this case time collisions can occur in a context of access through contention to the radiofrequency resources.

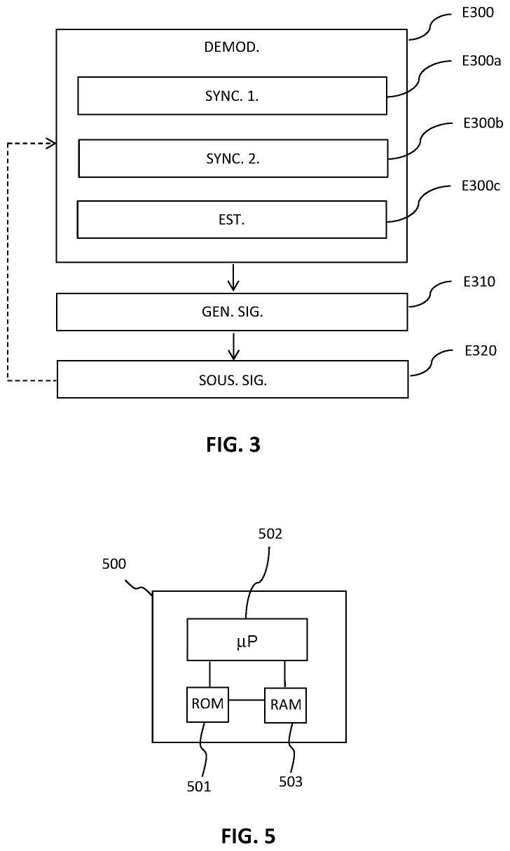

In relation with FIG. 2A, FIG. 2B and FIG. 2C, the modulation of a basic chirp via a circular permutation of the variation pattern of its instantaneous frequency is now presented.

A basic chirp is defined as the chirp from which are obtained the other chirps used for the transmission of the information following the modulation process by the modulation symbols.

More particularly, the instantaneous phase ϕ(t) (i.e., the phase of the complex envelope representing the chirp in question) of the basic chirp is expressed for t in the interval

$$[ - \frac{T}{2} , \frac{T}{2} )$$

### (FIG. 2A) as

$$ϕ ( t ) = 2 π \frac{B}{2 T} {( t )}^{2}$$

with:

T: the symbol duration (also called signaling interval for example in the LoRa® standard);

B=2SF/T: the bandwidth of the signal with SF the spreading factor, or number of bits per symbol (M=2SF is then the total number of symbols in the constellation of modulation symbols).

Based on these notations, the instantaneous frequency f(t) of the basic chirp, which corresponds to the derivative of the instantaneous phase ϕ(t), is expressed as

$$f ( t ) = \frac{B}{T} t$$

The instantaneous frequency f(t) is thus linked to the angular rotation speed in the complex plane of the vector the coordinates of which are given by the in-phase and quadrature phase signals representing the modulating signal (i.e. the real and imaginary portions of the complex envelope in practice) intended to modulate the radiofrequency carrier in such a way as to transpose the basic chirp signal over a carrier frequency.

The instantaneous frequency f(t) of the basic chirp shown in FIG. 2A is linear over time, i.e., varies linearly between a first instantaneous frequency, here −B/2, and a second instantaneous frequency, here +B/2, during the duration T of a symbol. Indeed, a chirp having a linear instantaneous frequency is used as a basic chirp (also called “raw” chirp) in the LoRa® standard.

In other embodiments, other types of basic chirps are considered, for example basic chirps the instantaneous frequency of which has a negative slope, or the instantaneous frequency of which does not vary linearly over time.

Returning to FIG. 2A, FIG. 2B and FIG. 2C, the modulation of a chirp corresponds, for a modulation symbol of rank s, to a circular permutation of the variation pattern of said instantaneous frequency over said symbol time T, obtained by a time shift of s times an elementary time duration Tc, such that M*Tc=T.

More particularly, it is possible to note fᵢ(t−pT) as being the instantaneous frequency of the chirp transmitted by the i-th connected object 100, i any integer from 1 to U, over the time interval

$$[ pT - \frac{T}{2} , pT + \frac{T}{2} ] .$$

The instantaneous frequency of the chirp in question is obtained by time shift of a duration

$${γ}_{i} ( p ) = \frac{{m}_{i} ( p )}{B}$$

of and circular permutation as shown in FIG. 2B and FIG. 2C. Here, mᵢ(p) is an integer between 0 and M−1 that represents the modulation symbol conveyed by the chirp transmitted by the i-th connected object 100 over the time interval

$$[ pT - \frac{T}{2} , pT + \frac{T}{2} ] .$$

In this way, fᵢ(t−pT) is expressed as the derivative of the instantaneous phase ϕᵢ(t−pT):

(Equation 1)

$${f}_{i} ( t - pT ) = \frac{1}{2 π} \frac{d {ϕ}_{i} ( t - pT )}{dt} .$$

The following is thus obtained over the time interval

$$[ pT - \frac{T}{2} , pT - \frac{T}{2} + {γ}_{i} ( p ) ) :$$

$${ϕ}_{i} ( t - pT ) = 2 π [ \frac{B}{2 T} {t}^{2} + \frac{{m}_{i} ( p )}{T} t ] . \qquad ( Equation 2 )$$

And over the time interval

$$[ pT - \frac{T}{2} + {γ}_{i} ( k ) , pT + \frac{T}{2} ) :$$

$${ϕ}_{i} ( t - pT ) = 2 π [ \frac{B}{2 T} {t}^{2} + ( \frac{{m}_{i} ( p )}{T} - B ) t ] . \qquad ( Equation 3 )$$

Thus, if xᵢ(t) denotes the complex envelope of the signal transmitted by the i-th connected object 100, there is:

$${x}_{i} ( t ) = {\sum }_{p ∈ ℤ} {e}^{j {ϕ}_{i} ( t - pT )} . \qquad ( Equation 4 )$$

Moreover, the signal transmitted by each object 100 follows the frame structure defined by the LoRa® standard. Such a frame starts with a preamble of Np basic chirps such as described hereinabove (i.e., the instantaneous frequency of which has a positive slope). Then comes a synchronization word which takes the form of two synchronization chirps having a predetermined modulation. Then, come 2.25 chirps referred to as SFD (for “Start of the Frame Delimiter”). Such SFD chirps correspond to non-modulated chirps but with an instantaneous frequency having a negative slope. In other terms, the chirps SFD can be seen as the conjugates (in terms of the mathematical operation to be applied to the corresponding complex envelopes) of the basic chirps. Then, the useful data flow is generated in the form of Nₛⁱ symbols.

Based on such a frame structure, a complex envelope of the signal transmitted by the i-th connected object 100 can be put in the form:

$${s}_{i} ( t ) = {{\sum }^{{N}_{p} - 1}}_{p = 0} {e}^{j ϕ ( t - pT )} + {{\sum }^{{N}_{p} + 1}}_{p = {N}_{p}} \text{?} + \text{?} {e}^{- j ϕ ( t - pT )} + \text{?} \qquad ( Equation 5 )$$

$$\text{?} \text{indicates text missing or illegible when filed}$$

Nₜ=Nₚ+4.25, and \tilde{ϕ}ₚ(t−pT) with the instantaneous phase of the synchronization word.

In this way, the complex envelope of the total signal received by the base station 110 can generally be written:

$$y ( t ) = {{\sum }^{U}}_{i = 1} \sqrt{{P}_{i}} {s}_{i} ( t - Δ {t}_{i} ) \text{?} + w ( t ) \qquad ( Equation 6 )$$

$$\text{?} \text{indicates text missing or illegible when filed}$$

with Pᵢ, θᵢ, Δtᵢ and Δfᵢ respectively the power, the initial phase, the time desynchronization shift and the frequency desynchronization shift of the signal received from the i-th object 100. Moreover, w(t) is the complex envelope of the noise in reception, here assumed to be additive white and Gaussian, or AWGN (for “Additive white Gaussian noise”).

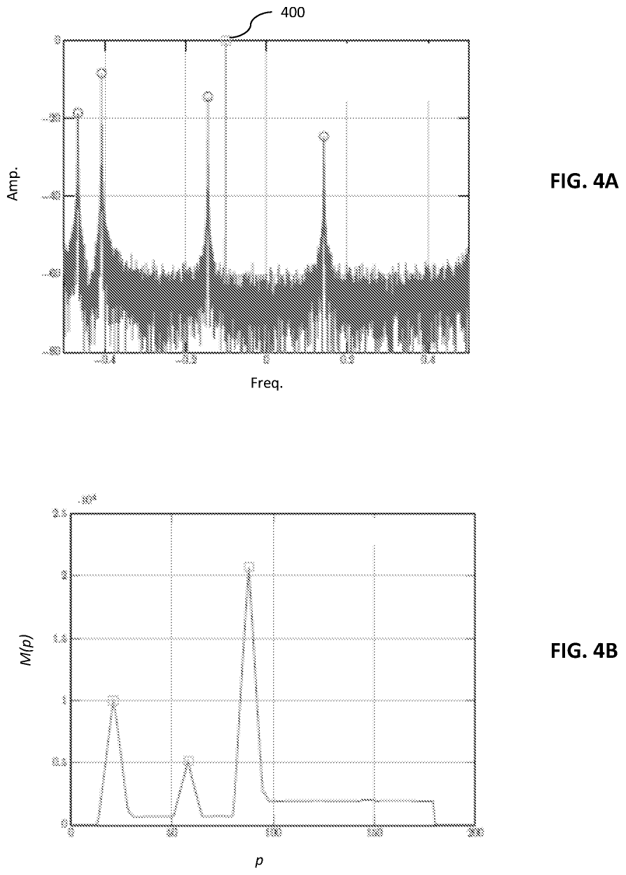

In relation with FIG. 3, the steps are now presented of a method for estimating information symbols according to an embodiment of the invention. More particularly, the signal y(t) the expression of which is given by the equation 6 is taken as an application example of the steps of the present method for estimating. Certain processing implemented by certain steps of the method for estimating are moreover shown further in FIG. 4A and FIG. 4B.

### Demodulation:

During a step E300, a demodulation of a portion of the signal y(t) is carried out by a device for estimating such as the device 500 described further hereinbelow in relation with FIG. 5. In the embodiment considered, the device 500 is comprised in the base station 110. In other embodiments, the device 500 is for example offset in a network core to which the base station 110 is connected or in another device for receiving signals emitted by the objects 100 (e.g., a piece of equipment for monitoring the network, etc.).

### First Synchronization:

Returning to FIG. 3, the device 500 continuously receives the signal y(t) the expression of which is given hereinabove by Equation 6. The device 500 implements a step E300a of first synchronization so as to be able to be synchronized over the useful portions of the signal y(t) conveying the data symbols.

To do this, the device 500 first carries out a sampling at the frequency B=1/Ts of the signal y(t) in such a way as to obtain the sequence (or the ordered set) of samples:

$$y ( n ) = {{\sum }^{U}}_{i = 1} \sqrt{{P}_{i}} {s}_{i} ( n - Δ {n}_{i} ) \text{?} + w ( n ) . \qquad ( Equation 7 )$$

$$\text{?} \text{indicates text missing or illegible when filed}$$

In the equation 7, Δnᵢ represents the time error between the signal y(t) defined hereinabove via the equation 6 and a de-chirping sequence used by the device 500 to cancel the instantaneous frequency slopes of the chirps. In practice, such a de-chirping sequence is a sequence of conjugated reference chirps. A conjugated reference chirp corresponds to the conjugate (in terms of the mathematical operation to be applied to the corresponding complex envelopes) of a reference chirp among the M modulated chirps. Such a conjugated reference chirp thus has an instantaneous frequency with a slope opposite that of the basic chirp. In other terms, the conjugated reference chirp is obtained by application of the modulation principle described hereinabove in relation with FIG. 2A, FIG. 2B and FIG. 2C to a basic chirp referred to as conjugated an instantaneous frequency of which varies between the second instantaneous frequency and the first instantaneous frequency during a symbol time T.

In what follows it is considered that the reference chirp corresponds to the basic chirp as shown in the expression (Equation 8) hereinbelow of the sequence implemented in the present embodiment. However, in other embodiments, other reference chirps among the M chirps of the constellation can be considered.

Likewise, the processing described in the present embodiment is based on a sampling at the frequency B=1/Ts of the signal y(t). In other embodiments, other sampling frequencies are considered, e.g., the integer multiple frequencies of B=1/Ts or even any sampling frequencies.

Returning to FIG. 3, it is generally possible to write the parameter Δnᵢ in the form

$$Δ {n}_{i} = \frac{Δ {t}_{i}}{{T}_{s}} = {K}_{i} M + {τ}_{i}$$

with Kᵢ a natural integer and τᵢ that can be put in the form τᵢ=└τᵢ┘+∈ᵢ with ϵᵢ ∈[0,1) and where └τᵢ┘ designates the integer part of τᵢ.

The device 500 thus carries out an element-wise multiplication between, on the one hand, the sequence y(n) of samples of the signal y(t) and, on the other hand, a sequence d(n) of samples that is representative of the de-chirping waveform:

$$d ( n ) = {\sum }_{p ∈ ℤ} {e}^{- j ϕ ( {nT}_{e} - pT )} . \qquad ( Equation 8 )$$

After application of a Fourier transform to the product of the sequence y(n) and of the sequence d(n), the following sequence is obtained:

$$Y ( k , p ) = \frac{1}{\sqrt{M}} {{\sum }^{M - 1}}_{n = 0} {\underbrace{( y ( n , p ) d ( n , p ) )}}_{z ( n , p )} {e}^{- j 2 π \frac{nk}{M}} \qquad ( Equation 9 )$$

$$with$$

$$\begin{matrix}z ( n , p ) = {{\sum }^{{U}_{p}}}_{i = 1} {z}_{{τ}_{i}} ( n , p ) + w ( n ) \\ = {{\sum }^{{U}_{p}}}_{i = 1} ( \sqrt{{P}_{i}} \text{?} {[ 0 , ⌊ {τ}_{i} ⌋ ]}_{} ( n ) + \\ \sqrt{{P}_{i}} {e}^{j ( 2 π n \frac{{\tilde{m}}_{i} ( {p}_{i} )}{M} + {ϕ}^{{p}_{i}} )} {[ ⌊ {τ}_{i} ⌋ + 1 , M - 1 ]}_{} ( n ) ) + w ( n )\end{matrix} \qquad ( Equation 10 )$$

$$\text{?} \text{indicates text missing or illegible when filed}$$

where:
Uₚ∈{1, . . . , U} is the number of signals received during the p-th time section of duration T of application of the de-chirping sequence d(n);
ϕ^{p}^{ᵢ}, for pᵢ∈{1, . . . , Nₜ+Nₛⁱ} is the initial phase of the i-th signal received during the pi-th section of duration T;
m̅ᵢ(pᵢ), pᵢ∈{1, . . . , Nₜ+Nₛⁱ} is the frequency of the detected peak of the i-th signal received from the pi-th section of duration T in a non-synchronized mode.

More particularly, the relation between m̅ᵢ(pᵢ) and the frequency mᵢ(pᵢ) of the symbol initially transmitted is expressed as follows:

m̅ᵢ(pᵢ)=mᵢ(pᵢ)+└τᵢ┘+└ΔfᵢT┘ mod M. (Equation 11)

However, the Nₚ symbols transmitted during the preamble of a LoRa® frame correspond to values mᵢ(pᵢ) that are zero. In this way, m̅ᵢ(pᵢ), for pi corresponding to a preamble chirp of a LoRa® frame, directly gives an estimation of the sum between the time synchronization error τᵢ and the frequency synchronization error Δfᵢ.

Thus, by favoring the signal having the highest amplitude transmitted by one of the objects 100, denoted via the index i=s in what follows, it is possible, via the estimation of the symbols conveyed by the preamble chirps, to obtain a first piece of synchronization information that is representative of a sum between the time synchronization error τₛ and the frequency synchronization error Δfₛ for the signal of stronger amplitude in question.

To do this, the detecting of the beginning of the preamble of the frame corresponding to the signal with the strongest amplitude transmitted by one of the objects 100 implements an averaging according to the transformed samples of the sequence given by the equation 9. For example, the detecting of the beginning of the preamble of the frame in question implements an averaging according to the squared modulus of the transformed sequence of samples delivered at the output of the Fourier transform and given by the equation 9. Such an averaging is advantageously done over the number NP of chirps composing the preamble (or, more generally, over a plurality of successive elementary portions of duration T of the processed signal), and slidingly over NB successive elementary portions of duration T (or, more generally, over several pluralities of successive elementary portions of duration T of the processed signal). The sequence T(k, p) is thus obtained, with k from 0 to M−1 and P from 1 to NB:

$$T ( k , p ) = {{\sum }^{p + {N}_{p} - 1}}_{j = p} {\vert \frac{Y ( k , j )}{{σ}_{w}} \vert}^{2} \qquad ( Equation 12 )$$

with σ_{w}² the variance of the noise w(t). Such a variance is for example estimated during the periods wherein no useful signal is received.

Based on the sequence T(k, p), an estimation K̅ₛ of the index Kₛ of the sample corresponding to the beginning of the preamble of the frame corresponding to the signal of stronger amplitude transmitted by one of the objects 100 is given by:

$${\hat{K}}_{s} = {arg max}_{p} ( M ( p ) ) \qquad ( Equation 13 )$$

with M(p) the function that represents the maximum values of T(k, p) for any p:

$$M ( p ) = {max}_{k} ( T ( k , p ) ) . \qquad ( Equation 14 )$$

Such a function M(p) is for example shown in FIG. 4B in the case where three objects 100 (i.e., U=3) emit to the base station 110.

In other embodiments, such an averaging over the number NP of chirps comprising the preamble and/or slidingly over NB successive elementary portions of duration T is not implemented, and the detecting of the beginning of the preamble of the frame corresponding to the signal with the strongest amplitude is done through simple searching for a maximum value among a sequence of delivered samples (e.g. the maximum value of the modulus of the samples in question) by a Fourier transform carried out on a multiplication of the signal received with an expected reference chirp (e.g. an expected reference chirp in the preamble of a data frame formed according to the LoRa® standard). FIG. 4A shows an example of such a sequence of samples delivered by the Fourier transform in question in the case where 3 objects 100 (i.e., U=3) emit to the base station 110. The index (or rank) of the peak 400 of stronger amplitude thus corresponds to the synchronization symbol sought in the signal of stronger amplitude emitted by an object 100. The other peaks correspond here to the signals emitted by the other objects 100.

Returning to FIG. 3, the peak of stronger amplitude at the output of the Fourier transform of the M samples that are representative of a preamble chirp makes it possible to obtain the first piece of synchronization information that is representative of a sum between the time synchronization error τₛ and the frequency synchronization error Δfₛ for the signal of stronger amplitude in question as described hereinabove in relation with the equation 11. By noting as m̅′ₛ the index of the peak of the signal of stronger amplitude in question, it is thus possible to write:

m̅′ₛ=(τₛ+ΔfₛT)mod M (Equation 15)

where mod designates the modulus function.

### Second Synchronization:

During a step E300b, the device 500 carries out a second synchronization.

More particularly, during the second synchronization the device 500 implements the same processing as during the first synchronization described hereinabove except that the de-chirping sequence considered is comprised of reference chirps having an instantaneous frequency with a slope identical to that of the basic chirp. In other terms, the reference chirps now considered are modulated chirps among the M chirps of the constellation. Such a de-chirping sequence now makes is possible to detect chirps having an instantaneous frequency with a slope opposite that of the detected during the first aforementioned synchronization. For example, such a de-chirping sequence makes it possible to detect the SFD chirps in a frame defined by the LoRa® standard.

Thus, all other things remaining equal with the first synchronization, the second synchronization makes it possible to obtain a second piece of synchronization information that is representative of a difference between the time synchronization error τₛ and the frequency synchronization error Δfₛ for the signal of stronger amplitude transmitted by one of the objects 100.

By noting as \hat{m}′ₛ the index of the peak of the signal of stronger amplitude in question estimated during the second synchronization, it is thus possible to write:

\hat{m}′ₛ=(τₛ−ΔfₛT)mod M (Equation 16)

where mod designates the modulus function.

In this way, by implementing an addition and a subtraction between the first piece of synchronization information and the second piece of synchronization information, the device 500 determines the time synchronization error τₛ and the frequency synchronization error Δfₛ for the signal of stronger amplitude received from one of the objects 100. Such time and frequency synchronization errors make it possible to estimate with precision the data symbol or symbols conveyed by the chirp or chirps of the signal of stronger amplitude.

In other embodiments, a single synchronization is carried out (the first synchronization or the second synchronization) allowing for a time shifting which, although less precise, is sufficient in certain conditions to estimate the data symbol or symbols conveyed by the signal to be processed.

In certain embodiments, the second synchronization takes account of the first piece of synchronization information so as to synchronize the processing over the portion of the signal conveying the chirps having an instantaneous frequency with a slope opposite that of the chirps detected during the first synchronization.

### Management of False Alarms:

Returning to FIG. 3, as described hereinabove, the first synchronization and the second synchronization are based on the detection of extreme values in the sequence T(k, p) defined by Equation 12. In practice, such a detection is done through comparison with a first predetermined threshold.

More particularly, the Fourier transform of the noise w(t), assumed to be Gaussian, also follows a Gaussian distribution. It can thus be shown that T(k, p) follows a chi-square distribution law with NP degrees of freedom.

Thus, if P_{fa} denotes the probability of a false alarm, the following hypotheses can be defined:

[symbol]

₀: {Uⱼ=0,∀∈{p, . . . ,p+Np}}; and

[symbol]

₁: {∃j∈{p, . . . ,p+Np},Uⱼ≠0}.

The following can thus be written:

$$\begin{matrix}{P}_{fa} = P [ {ℋ}_{1} / {ℋ}_{0} ] \\ = P [ T ( k , p ) > Th / ( T ( k , p ) \sim {χ}^{2} ( . ; {N}_{p} ) ] \\ = 1 - P [ T ( k , p ) < Th / ( T ( k , p ) \sim {X}^{2} ( . ; {N}_{p} ) ] \\ = 1 - {F}_{{χ}^{2}} ( Th ; {N}_{p} )\end{matrix} \qquad ( Equation 17 )$$

with F_{χ}_{²}(·; Nₚ) the cumulative distribution function of the chi-square distribution with N_{P} degrees of freedom.

For a predetermined probability P_{fa} of a false alarm, the first predetermined threshold Th beyond which it is estimated that a peak corresponds to a chirp that is effectively present in the signal to be processed is expressed as:

Th=F_{χ}_{²}⁻¹(1−P_{fa};Nₚ). (Equation 18)

In this way, if T(k, p)<Th for any p from 1 to NB (or more generally for any p from 1 to the total number of successive elementary portions of duration T of the signal over which the average defining T(k, p) is taken (note that in this case, the first threshold Th is according to the total number of successive elementary portions in question), no synchronization is carried out and no estimation is delivered at the end of the implementation of the step E300 of demodulation.

On the contrary, if T(k, p) is greater than or equal to the first predetermined threshold Th, it is decided that a peak is detected, i.e., a chirp conveying a corresponding symbol is detected.

### Estimating a Data Symbol:

Once the synchronization information is available, during a step E300c, the device 500 estimates one (or more) data symbols conveyed by one (or more) corresponding chirps in the signal of stronger amplitude received from one of the objects 100. To do this, the aforementioned principles of multiplication with a de-chirping sequence are implemented again, but over a resynchronized signal. In other terms, the device 500 carries out, for a portion of the processed signal that is representative of the chirp conveying the data symbol in question:
a sampling referred to as synchronized at the frequency M/T of the portion of the processed signal initiated according to the first piece of synchronization information and/or the second piece of synchronization information delivering a sequence (or ordered set) of M synchronized samples that are representative of the chirp in question;
an element-wise multiplication referred to as synchronized between, on the one hand, the sequence of M synchronized samples and, on the other hand, a sequence of M samples that are representative of the conjugated reference chirp (such as described hereinabove), the multiplication delivering a sequence of M multiplied synchronized samples; and
a Fourier transform referred to as synchronized of the sequence of M multiplied synchronized samples delivering a sequence of M transformed synchronized samples.

For example, when this processing is applied to the Ps-th elementary section of synchronized length T:
the index \hat{m}ₛ(pₛ) of the peak of higher amplitude among the M transformed synchronized samples is representative of the data symbol conveyed by the chirp temporally located in the Pₛ-th section in question;
the amplitude of the peak in question is representative of the amplitude \sqrt{\hat{P}ₛ^{P}^{ₛ}} of the chirp in question; and
the phase of the peak in question is representative of the phase \hat{ϕ}^{p}^{ₛ} of the chirp in question.

However, in certain embodiments, a management of superimposed peaks is proposed. Such superimposed peaks are for example present at the output of the Fourier transform when two chirps emitted by two different objects 100 but conveying the same modulation symbol arrive at the same time at the device 500.

More particularly, the principle here is to compare the amplitude of the peak of the higher amplitude among the M transformed synchronized samples with a second predetermined threshold Th′.

For example, the second predetermined threshold Th′ is according to the average value of the peaks of higher amplitude detected in each one of the successive chirps. To do this, the sampling synchronized at the frequency M/T of the processed signal initiated according to the first piece of synchronization information and/or the second piece of synchronization information is prolonged in such a way as to deliver a plurality of sequences of M synchronized samples. Each sequence of M synchronized samples is representative of a corresponding fraction of duration T of the processed signal. The fractions in question are thus successive. Moreover, synchronized element-wise multiplication and the synchronized Fourier transform are implemented for each sequence of M synchronized samples of the plurality of sequences of M synchronized samples delivering a corresponding plurality of sequences of M transformed synchronized samples.

Thus, an average amplitude \sqrt{Pₛ} corresponding to the average of the amplitudes of each sample of stronger amplitude of each sequence of M transformed synchronized samples is obtained. Moreover, an average phase ϕ̅ corresponding to the average of the phases of each sample of stronger amplitude of each sequence of M transformed synchronized samples is obtained.

Knowing that the Fourier transform of the noise w(t), assumed to be Gaussian, also follows a Gaussian distribution, |Yₛ(k, pₛ)| follows Rice's law [symbol] ᵢ(u, v) with u the location parameter and v the scale parameter, such that:

|Yₛ(k, pₛ)| is proportional to [symbol] ᵢ(\sqrt{PₛM}, σ_{w}) when k=mₛ(pₛ); and

|Yₛ(k, pₛ)| is proportional to [symbol] ᵢ(0, σ_{w}) otherwise.

Thus, the following hypotheses can be defined:

H₀: a single peak exists for a given index k; and

H₁: several peaks exist and are superimposed for a given index k.

By taking the same definition for the probability of a false alarm P′_{fa} in the present case as for the probability P_{fa} described hereinabove, the following is obtained:

Th′=F [symbol] _{ᵢ}⁻¹(1−P′_{fa};\sqrt{PₛM},σ_{w}) (Equation 19)

Thus, the amplitude of the peak of the higher amplitude among the M transformed synchronized samples is compared to the second predetermined threshold Th′. If the amplitude of the peak in question is greater than Th′, it is decided that there are several superimposed peaks, otherwise it is decided that a single peak is present. For example, it is decided that the amplitude \sqrt{P̅ₛ^{p}^{ₛ}} of the chirp corresponding to the sample of stronger amplitude is according to:
the amplitude of the sample of stronger amplitude when the amplitude of the sample in question is less than the second predetermined threshold Th′, and
a predetermined amplitude, e.g., the average amplitude \sqrt{P̅ₛ}, when the amplitude of the sample of stronger amplitude is greater than the second predetermined threshold Th′.

Likewise, it is decided that the phase \hat{ϕ}^{p}^{ₛ} of the chirp corresponding to the sample of stronger amplitude is according to:
the phase of the sample of stronger amplitude when the amplitude of the sample in question is less than the second predetermined threshold Th′, and
a predetermined phase, e.g., the average phase ϕ̅, when the amplitude of the sample of stronger amplitude is greater than the second predetermined threshold Th′.

### Obtaining and Use of an Estimation Bias:

In certain embodiments, the step E300c (according to any one of the aforementioned embodiments) is implemented for a portion of the signal that is representative of an expected chirp, e.g., a chirp present in the preamble of a frame emitted by one of the objects 100.

In this way, by comparison of the symbol conveyed by the expected chirp such as estimated by the implementation of step E300c with the expected value of the symbol in question, an estimation bias is obtained. For example, the bias corresponds to a difference between the expected index of the peak of stronger amplitude at the output of the Fourier transform and the index actually obtained at the output of the Fourier transform during the implementation of step E300c.

Such an estimation bias is for example taken into account during a later implementation of step E300c (according to any of the aforementioned embodiments) so as to estimate a data symbol conveyed by a chirp of the processed signal. Indeed, although step E300a of first synchronization and/or step E300b of second synchronization is implemented, a residual synchronization error can occur. In this framework, obtaining the estimation bias and using it to estimate the data symbols makes it possible to improve the overall demodulation performance.

Generating and Subtracting the Signal that is Representative of the Chirp of Stronger Amplitude:

Returning to FIG. 3, based on the index \hat{m}ₛ(pₛ), the amplitude \sqrt{P̅ₛ^{p}^{ₛ}} and the phase \hat{ϕ}^{p}^{ₛ}, during a step E310 the device 500 generates a signal that is representative of the chirp of stronger amplitude. For example, the following complex envelope is generated:

(Equation 20)

$$\text{?} ( n , {p}_{s} ) = \text{?} .$$

$$\text{?} \text{indicates text missing or illegible when filed}$$

Thus, during a step E320, the device 500 subtracts the signal that is representative of the chirp of stronger amplitude from the processed signal. Such a subtraction is done coherently, i.e., in such a way as to cancel the signal corresponding to the chirp of stronger amplitude within the processed signal. For example, the subtraction takes account of the first piece of synchronization information and the second piece of synchronization information so as to obtain such a coherency. An updated signal wherein the chirp of stronger amplitude was canceled is thus generated.

### Iteration of the Method:

Based on the updated signal, step E300 (according to any of the aforementioned embodiments) is again implemented in order to estimate the parameters of the new chirp of stronger amplitude present within the updated signal.

According to certain embodiments, an iterative method is thus implemented wherein for each iteration the parameters of the chirp of stronger amplitude within the processed signal are estimated (step E300), a signal that is representative of the chirp of stronger amplitude is generated (step E310) then subtracted (step E320) from the processed signal in order to obtain an updated processed signal used for the following iteration. In this way, for a chirp of given amplitude, the interferences constituted by the chirps of stronger amplitude are canceled, or at the least minimized, as the iterations occur before demodulating the chirp of given amplitude in question.

According to certain embodiments, the implementations of step E300 are identical at each iteration. According to other embodiments, some (or all) of the implementations of step E300 are different according to the iteration considered. For example, the first synchronization and the second synchronization are implemented only during the first iterations, when the interferences are the most numerous. For the following iterations, only one synchronization (the first or the second synchronization) is implemented.

In certain embodiments, the steps of the method are implemented a predetermined number of iterations. In other embodiments, the steps of the method are implemented until no symbol is detected in the processed signal during the implementation of step E300.

In relation with FIG. 5 an example is now presented of the device structure 500 making it possible to implement certain steps of the method for estimating of FIG. 3 according to an embodiment of the invention.

The device 500 comprises a live memory 503 (for example a RAM memory), a processing unit 502 equipped for example with a processor and controlled by a computer program stored in a read-only memory 501 (for example a ROM memory or a hard drive). At initialization, the code instructions of the computer program are for example loaded into the live memory 503 before being executed by the processor of the processing unit 502.

This FIG. 5 shows only one particular manner, among several possible, of carrying out the device 500 so that it carries out certain steps of the method for estimating according to the invention (according to any of the embodiments and/or alternatives described hereinabove in relation with FIG. 3). Indeed, these steps can be carried out indifferently on a reprogrammable calculation machine (a PC computer, a DSP processor or a microcontroller) executing a program comprising a sequence of instructions, or on a dedicated calculation machine (for example a set of logic gates such as a FPGA or an ASIC, or any other hardware module).

In the case where the device 500 is carried out with a reprogrammable calculation machine, the corresponding program (i.e., the sequence of instructions) can be stored in a removable storage medium (such as for example a CD-ROM, a DVD-ROM, a USB key) or not, this storage medium able to be read partially or entirely by a computer or a processor.

In certain embodiments, the device 500 is included in the base station 110.

In certain embodiments, the device 500 is included in an object 100.

In certain embodiments, the device 500 is included in equipment for monitoring the radiocommunications network.

In certain embodiments, the device 500 is included in a node of the radiocommunications network.

1-17. (canceled)

18. A method for estimating at least two information symbols of a constellation of M symbols conveyed by a signal, the signal comprising a plurality of chirps among M chirps wherein a s-th chirp among the M chirps is associated with a modulation symbol of a rank s of the constellation of M symbols, s being an integer from 0 to M−1,
the s-th chirp resulting from a modulation of a chirp of which an instantaneous frequency varies between a first instantaneous frequency and a second instantaneous frequency during a symbol time T, the modulation corresponding, for the modulation symbol of rank s, to a circular permutation of a variation pattern of the instantaneous frequency over the symbol time T, obtained by a time shift of s times an elementary time duration Tc, such that M*Tc=T,
the method comprising, for a portion of the signal representative of at least two chirps of the plurality of chirps:
a first demodulation of the portion of the signal, the first demodulation providing an estimation of a first modulation symbol associated with a first chirp, having a stronger amplitude among said at least two chirps, an estimation of an amplitude of the first chirp, and an estimation of a phase of the first chirp;
generation of a signal that is representative of the first chirp from the estimation of the first modulation symbol, the estimation of the amplitude of the first chirp, and the estimation of the phase of the first chirp;
a coherent subtraction of the signal that is representative of the first chirp from the portion of the signal representative of the at least two chirps, to provide an updated portion of the signal; and
a second demodulation of the updated portion of the signal to provide an estimation of a second modulation symbol associated with a second chirp among said at least two chirps.

19. The method of claim 18, wherein the first demodulation and the second demodulation comprise a first synchronization comprising, for at least one first elementary portion of duration T of the signal:
a first sampling of said at least one first elementary portion to provide a sequence of first samples;
a first element-wise multiplication between the sequence of first samples and a sequence of samples representative of a conjugated reference chirp obtained by an application of the modulation to a conjugated basic chirp an instantaneous frequency of which varies between the second instantaneous frequency and the first instantaneous frequency during the symbol time T, the first element-wise multiplication providing a sequence of first multiplied samples; and
a first Fourier transform of the sequence of first multiplied samples to provide a sequence of first transformed samples, and
the first synchronization providing a first piece of synchronization information of the signal according to the sequence of first transformed samples.

20. The method of claim 19, wherein the first element-wise multiplication and the first Fourier transform are implemented, for at least one plurality of first successive elementary portions of duration T of the signal, to provide at least one plurality of sequences of first transformed samples; wherein the first synchronization comprises, for said at least one plurality of sequences of first transformed samples, at least one first averaging according to first transformed samples of a same rank within sequences of first transformed samples of said at least one plurality of sequences of first transformed samples; wherein said at least one first averaging is repeated for all ranks of the first transformed samples within the sequences of first transformed samples of said at least one plurality of sequences of first transformed samples, to provide a sequence of first averaged transformed samples; and wherein the first piece of synchronization information is according to a maximum value among the sequence of the first averaged transformed samples.

21. The method of claim 20, wherein the first element-wise multiplication and the Fourier transform are implemented, for at least two pluralities of first successive elementary portions of duration T of the signal, to provide at least two pluralities of sequences of first transformed samples; wherein said at least one first averaging is implemented, for each plurality of sequences of first transformed samples, to provide at least two sequences of first averaged transformed samples, and wherein the first piece of synchronization information is according to a maximum value among said at least two sequences of first averaged transformed samples.

22. The method of claim 20, wherein the first demodulation and the second demodulation provide the estimations if and only if the maximum value is greater than a first predetermined threshold.

23. The method of claim 21, wherein the first demodulation and the second demodulation provide the estimations if and only if the maximum value is greater than a first predetermined threshold.

24. The method of claim 19, wherein the first demodulation and the second demodulation comprise a second synchronization comprising, for at least one second elementary portion of duration T of the signal:
a second sampling of said at least one second elementary portion to provide a sequence of second samples;
a second element-wise multiplication between the sequence of second samples and a sequence of samples representative of a reference chirp among the M chirps, the second element-wise multiplication providing M second multiplied samples; and
a second Fourier transform of the M second multiplied samples to provide a sequence of second transformed samples,
the second synchronization providing a second piece of synchronization information of the signal according to the sequence of second transformed samples.

25. The method of claim 24, wherein the second element-wise multiplication and the second Fourier transform are implemented, for at least one plurality of second successive elementary portions of duration T of the signal, to provide at least one plurality of sequences of second transformed samples; wherein the second synchronization comprises, for said at least one plurality of sequences of second transformed samples, at least one second averaging according to second transformed samples of a same rank within sequences of second transformed samples of said at least one plurality of sequences of second transformed samples; wherein said at least one second averaging is repeated for all ranks of the second transformed samples within the sequences of second transformed samples of said at least one plurality of sequences of second transformed samples, to provide a sequence of second averaged transformed samples; and wherein the second piece of synchronization information is according to a maximum value among the sequence of second averaged transformed samples.

26. The method of claim 25, wherein the second element-wise multiplication and the second Fourier transform are implemented, for at least two pluralities of second successive elementary portions of duration T of the signal, to provide at least two pluralities of sequences of second transformed samples; wherein the second averaging is implemented, for each plurality of sequences of second transformed samples, to provide at least two sequences of corresponding second averaged transformed samples; and wherein the second piece of synchronization information is according to a maximum value among the at least two sequences of second averaged transformed samples.

27. The method of claim 24, wherein, one of the first and second pieces of synchronization information is representative of a sum between a time synchronization error and a frequency synchronization error, and other of the first and second pieces of synchronization information is representative of a difference between the time synchronization error and the frequency synchronization error; and wherein the first demodulation and the second demodulation comprise an addition and a subtraction, between the first and the second pieces of synchronization information, to provide the time synchronization error and the frequency synchronization error.

28. The method of claim 24, wherein the first demodulation and the second demodulation comprise, for at least one fraction of duration T of a signal portion that is representative of an expected chirp, referred to as an expected fraction:
a synchronized sampling of the expected fraction, initiated according to the first piece of synchronization information and the second piece of synchronization information, to provide a sequence of expected synchronized samples that are representative of the expected chirp;
a synchronized element-wise multiplication, between the sequence of expected synchronized samples and the sequence of samples representative of the conjugated reference chirp, to provide a sequence of expected multiplied synchronized samples;
a synchronized Fourier transform of the sequence of expected multiplied synchronized samples, to provide a sequence of expected transformed synchronized samples,
an estimation bias of the expected chirp being according to an expected transformed synchronized sample of a peak amplitude among expected transformed synchronized samples; and
wherein the first demodulation and the second demodulation providing at least one estimation bias corresponding to the expected chirp.

29. The method of claim 28, wherein the first demodulation and the second demodulation comprise, for at least one fraction of duration T of the signal portion that is representative of the first chirp, referred to as a first chirp fraction, and for at least one fraction of duration T of the signal portion that is representative of the second chirp, referred to as second chirp fraction:
a synchronized sampling of the first chirp fraction and of the second chirp fraction, initiated according to the first piece of synchronization information and the second piece of synchronization information, to provide a sequence of first synchronized samples that are representative of the first chirp and a sequence of second synchronized samples that are representative of the second chirp;
a synchronized element-wise multiplication, between the sequence of first synchronized samples and the sequence of samples that are representative of the conjugated reference chirp and between the sequence of second synchronized samples and the sequence of samples that are representative of the conjugated reference chirp, to provide a sequence of first multiplied synchronized samples and a sequence of second multiplied synchronized samples, respectively;
a synchronized Fourier transform of the sequence of first multiplied synchronized samples and the sequence of second multiplied synchronized samples to provide a sequence of first transformed synchronized samples and a sequence of second multiplied synchronized samples, respectively;
the estimations associated with the first chirp being according to a first transformed synchronized sample of a peak amplitude among first transformed synchronized samples and the estimations associated with the second chirp being according to a second transformed sample of a peak amplitude among second transformed synchronized samples.

30. The method of claim 29, wherein the estimations associated with the first chirp and the second chirp are in addition to said at least one estimation bias.

31. The method of claim 29, wherein the first demodulation comprises a comparison between an amplitude of the first transformed synchronized sample of the peak amplitude, referred to as a first sample of peak amplitude, and a second predetermined threshold;
wherein the estimation of the amplitude of the first chirp is according to: the amplitude of the first sample of peak amplitude when the amplitude of the first sample of peak amplitude is less than the second predetermined threshold, and a predetermined amplitude when the amplitude of the first sample of peak amplitude is greater than the second predetermined threshold; and
wherein the estimation of the phase of the first chirp is according to: a phase of the first sample of peak amplitude when the amplitude of the first sample of peak amplitude is less than the second predetermined threshold, and a predetermined phase when the amplitude of the first sample of peak amplitude is greater than the second predetermined threshold.

32. The method of claim 31, wherein the synchronized sampling of the first chirp fraction is prolonged over time to provide a plurality of sequences of synchronized samples that are representative of a plurality of successive fractions of duration T of the signal portion; wherein the synchronized element-wise multiplication and the synchronized Fourier transform are implemented, for each sequence of synchronized samples, to provide a plurality of sequences of transformed synchronized samples; wherein the predetermined amplitude being according to an average of amplitudes of each sample of said plurality of sequences of transformed synchronized samples; and wherein the predetermined phase being according to an average of phases of said each sample of said plurality of sequences of transformed synchronized samples.

33. The method of claim 18, wherein the portion of the signal is representative of at least three chirps of the plurality of chirps, the first chirp being one with a maximum amplitude among said at least three chirps; wherein the second modulation symbol being associated with a second chirp with a next maximum amplitude after the first chirp among said at least three chirps; wherein the second demodulation provides an estimation of an amplitude of the second chirp and an estimation of a phase of the second chirp, the method further comprising:
generating a signal that is representative of the second chirp from the estimation of the second modulation symbol, estimation of the amplitude of the second chirp and estimation of the phase of the second chirp;
a coherent subtraction of the signal that is representative of the second chirp from the updated portion of the signal, to provide a second updated portion of the signal; and
a third demodulation of the second updated portion of the signal, to provide an estimation of a third modulation symbol associated with a third chirp.

34. A computer program product executable by a processor-based computer, comprising a program code of instructions to implement the method of claim 18.

35. A device to estimate at least two information symbols of a constellation of M symbols conveyed by a signal comprising a plurality of chirps among M chirps, wherein an s-th chirp among the M chirps is associated with a modulation symbol of rank s of the constellation of M symbols, s being an integer from 0 to M−1,
the s-th chirp resulting from a modulation of a chirp of which an instantaneous frequency varies between a first instantaneous frequency and a second instantaneous frequency during a symbol time T, the modulation corresponding, for the modulation symbol of rank s, to a circular permutation of a variation pattern of the instantaneous frequency over the symbol time T, obtained by a time shift of s times an elementary time duration Tc, such that M*Tc=T,
wherein the device comprises a processor configured to perform, for a portion of the signal representative of at least two chirps of the plurality of chirps:
a first demodulation of the portion of the signal, the first demodulation providing an estimation of a first modulation symbol associated with a first chirp, having a stronger amplitude among the at least two chirps, an estimation of an amplitude of the first chirp, and an estimation of a phase of the first chirp;
generating a signal that is representative of the first chirp from the estimation of the first modulation symbol, the estimation of the amplitude of the first chirp, and the estimation of the phase of the first chirp;
a coherent subtraction of the signal that is representative of the first chirp from the portion of the signal, to provide an updated portion of the signal; and
a second demodulation of the updated portion of the signal to provide an estimation of a second modulation symbol associated with a second chirp among said at least two chirps.
